(19) United States
(12) Patent Application Publication
(10) Pub. No.: US 2005/0179922 A1
(43) Pub. Date: Aug. 18, 2005

(54) Methods and apparatus for providing printer drivers to a user

(76) Inventors: Ward S. Foster, Boise, ID (US); Eugenio G. Walters, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/777,372

(22) Filed: Feb. 12, 2004

(51) Int. Cl. G06F 15/00

(52) U.S. Cl. 358/1.13; 358/1.15

(57) ABSTRACT

The present invention provides a computer-accessible storage media including a database of one or more data files, each including a printer type identification, one or more substitute printer driver identifications associated with the printer type identification, and one or more compatibility ratings associated with the printer type identification and a particular one of the one or more substitute printer driver identifications. A method of the present invention includes the steps of accessing a database, displaying a database listing including a printer type identification, one or more substitute printer driver identifications associated with the printer type identification, and one or more compatibility ratings associated with the printer type identification and a particular one of the substitute printer driver identifications. The method further includes issuing a selection command, and establishing an operational association between a substitute printer driver and a printer in accordance with the selection command.

### BACKGROUND

The use of various imaging apparatus for forming images (e.g., text and/or graphics, etc.) onto sheet media, so as to produce a corresponding hardcopy or document, is well known. In a typical exemplary operation, the production of such a document involves the derivation of a print ready data file from an electronic document file (i.e., original) by way of a printer driver. Thereafter, or contemporaneous with the derivation, the print ready data file is transmitted to an imaging apparatus (e.g., a printer) for imaging onto sheet media.

Under such an exemplary operation, a printer driver that corresponds directly to the particular type (make and model) of imaging apparatus is used. Such a printer driver is usually provided with the imaging apparatus at the time of original purchase on some form of computer-readable media (e.g., CD-ROM, etc.), and/or is available by way of a file download from an Internet-accessible website. In any case, a particular printer driver associated with a given imaging apparatus is generally provided or is readily available.

Occasionally, a particular printer driver becomes corrupt and is no longer suitable for use with the intended imaging apparatus. On other occasions, a printer driver has been newly introduced to the market in association with a correspondingly new imaging apparatus, but the printer driver has an unknown defect or other problem. Still other situations occur wherein a particular printer driver is generally satisfactory for use, except when attempting to derive a print ready data file from a specific type of electronic document file. Yet another situation occurs in which a particular printer driver does not perform as desired, if it all, within certain kinds of managed printing systems or environments due, for example, to an incompatibility between the printer driver and the printing system management application. Under these and other situations, it is desirable to make use (or attempt to make use) of a printer driver other than that originally intended for operation with a particular imaging apparatus—in other words, to use a substitute printer driver.

Therefore, it is generally desirable to provide methods and apparatus directed to the use of substitute printer drivers.

### SUMMARY

One embodiment of the present invention provides for a computer-accessible storage media including a database of one or more data files, wherein each of the one or more data files includes a printer type identification. Each of the one of more data files also includes one or more substitute printer driver identifications associated with the printer type identification, and one or more compatibility ratings associated with the printer type identification and a particular one of the one or more substitute printer driver identifications.

Another embodiment of the present inventions provides a method of managing a system, the method including the steps of receiving an error message indicative of an operational problem with a printer driver of the system, and accessing a computer-accessible database including one or more data records. The method also includes the steps of displaying a listing corresponding to the contents of the one or more data records, each data record including a printer type identification, one or more substitute printer driver identifications associated with the printer type identification, and one or more compatibility ratings associated with the printer type identification and a particular one of the substitute printer driver identifications, and issuing a selection command corresponding to a particular one of the displayed substitute printer driver identifications. The method further includes the step of establishing an operational association between a substitute printer driver and a printer of the system in accordance with the selection command.

These and other aspects and embodiments will now be described in detail with reference to the accompanying drawings, wherein:

### DESCRIPTION OF THE DRAWINGS

FIG. 1 is a block diagram depicting a system, in accordance with one embodiment of the present invention.

FIG. 2 is a block diagram depicting a database listing, in accordance with another embodiment of the present invention.

FIG. 3 is a flowchart depicting a method, in accordance with the present invention.

FIG. 4 is a flowchart depicting another method, in accordance with the present invention.

FIG. 5 is a flowchart depicting still another method, in accordance with the present invention.

FIG. 6 is a flowchart depicting yet another method, in accordance with the present invention.

### DETAILED DESCRIPTION

In representative embodiments, the present teachings provide methods and apparatus for defining, maintaining, accessing and using a database of information for making substantially productive use of substitute printer drivers with various imaging apparatus (e.g., printers). Such a database generally includes a plurality of data records, wherein each data record includes a printer type identification, one or more substitute printer driver identifications associated with the printer type identification, and one or more compatibility ratings associated with (i.e., correlating) the printer type identification with a particular one of the substitute printer driver identifications of that particular data record.

A database, according to the present invention, is typically provided (i.e., stored and maintained) on a generally local, networked server referred to herein as a mobile enterprise printing (MEP) server. In such an embodiment as just described, the database is generally referred to herein as a computer-accessible database. Also, a database according to the present invention can be provided on an MEP host computer, which is publicly-accessible by way of one or more Internet web pages. Thus, such an embodiment of the present invention is generally referred to as a network-accessible database.

In any case, a database in accordance with an embodiment of the present invention can provide information to a systems administrator or other suitably authorized user so that substitute (i.e., alternative) printer drivers can be effectively used in association with particular imaging apparatus (“printers”) of a data handling system.

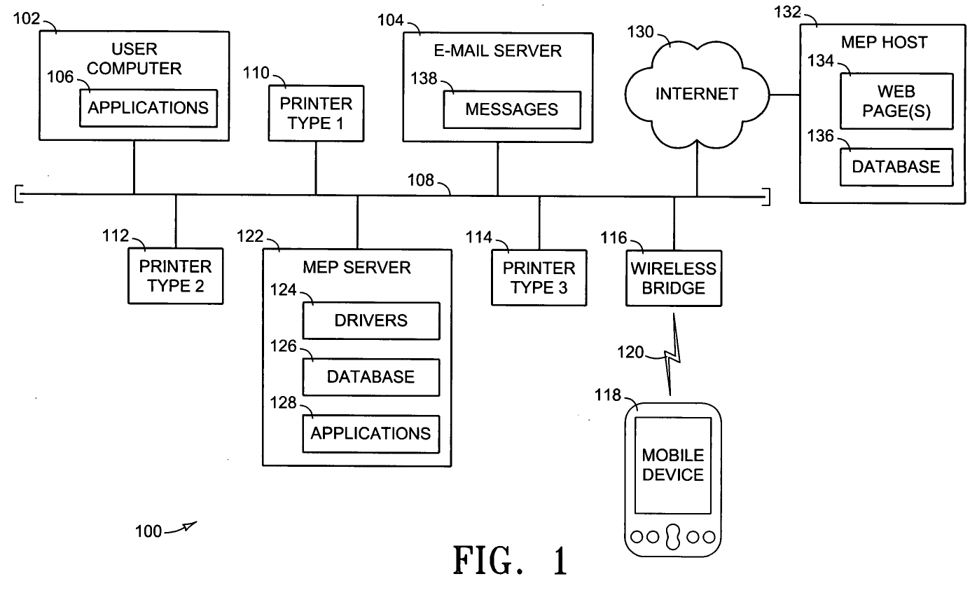

Turning now to FIG. 1, a block diagram depicts a system 100, in accordance with one embodiment of the present invention. The system 100 includes a user computer 102. The user computer 102 can be defined by any suitable computer such as, for example, a desktop computer, a laptop computer, etc., configured to perform a range of computing functions (e.g., program execution, data manipulation, electronic file generation, etc.). The user computer 102 further includes at least one executable application (i.e., program file) 106. Furthermore, the user computer 102 is coupled in data and/or signal communication with other devices of the system 100 by way of a suitable network 108. One of skill in the computing arts can appreciate that the user computer 102, as well as the network 108, are generally well known and that further elaboration thereof is not required for purposes of understanding the present invention.

The system 100 also includes an e-mail server 104 coupled in data and/or signal communication with the network 108. The e-mail server 104 is configured to perform a number of typical e-mail receiving, storing and routing operations and can be generally defined by any such server suitable for such purposes. As depicted in FIG. 1, the e-mail server 104 stores one or more electronic messages 138 and/or electronic document attachments respectively awaiting download by their intended recipients.

The system 100 also includes a first type printer 110, a second type printer 112, and a third type printer 114, each respectively coupled in data and/or signal communication with the network 108. The first, second and third type printers 110, 112 and 114 are defined by respectively different types (make and/or model) of imaging apparatus, and each is generally configured to form images on sheet media in accordance with a print-ready data file (not shown) received by way of the network 108. Further elaboration of the first, second, and third type printers 110, 112 and 114 is provided hereinafter.

The system 100 also includes wireless bridge 116. The wireless bridge is configured to couple one or more kinds of mobile devices 118 in bidirectional data and/or signal communication with the network 108 by way of wireless signals 120. In this way, the wireless bridge 116 can be generally defined as transceiver type of device. Furthermore, the wireless bridge 116 can be configured so that the wireless signals 120 are defined by any suitable such signals such as, for example, infrared signals, radio frequency (RF) signals, Bluetooth® signals, etc. Bluetooth is a registered mark owned by Bluetooth Sig, Inc., Washington, D.C. 20005. In any case, the wireless transceiver is configured to facilitate the bidirectional exchange of information, data and/or control signals between various system 100 devices (e.g., the user computer 102, the first type printer 110, etc.) and one or more kinds of mobile devices 118 by way of the wireless signals 120.

The system 100 also includes a mobile device 118 as introduced above. As depicted in FIG. 1, the mobile device 118 is generally defined by a handheld computer. One example of such a handheld computer is the HP iPAQ Pocket PC h4350 available from Hewlett-Packard Company, Palo Alto, Calif. 94304. Other types of mobile devices (not shown) can also be used such as, for example, laptop computers, personal digital assistants (PDA's), network-capable cellular telephones, etc. The mobile device 118 is typically configured to perform any number of computing and/or data manipulation tasks, and to wirelessly communicate data and/or signals between itself and one or more of the system 100 devices by way of the wireless signals 120, the wireless bridge 116 and the network 108. Further elaboration of the mobile device 118 is provided hereinafter in regard to a typical operation of the system 100.

The system 100 also includes a mobile enterprise printing (MEP) server 122, in accordance with the present invention. The MEP server (i.e., server) 122 is coupled in data and signal communication with the other system 100 devices by way of the network 108. The MEP server 122 is configured to perform any number of typical server functions such as, for example, data file storage, transfer of electronic messages and electronic documents between other devices of the system 100, execution of network applications (programs), etc. The MEP server 122 is also configured to perform a number of operations particular to the present invention and as elaborated in further detail hereinafter. The MEP server 122 includes one or more printer drivers 124, a mobile enterprise printing driver database (hereinafter, computer-accessible database) 126, and one or more application program files 128.

As depicted in FIG. 1, the system 100 further includes a connection to the Internet 130 by way of the network 108. The system 100 also includes a mobile enterprise printing host server (MEP host) 132, which is accessible by the MEP server 122 and/or other devices of the system 100 by way of the network 108 and the Internet 130. Thus, the MEP host 132 generally defines an Internet-accessible device. The MEP host 132 includes one or more Internet-accessible web pages 134 and a mobile enterprise printer driver database (hereinafter, network-accessible database) 136. Further details of the MEP host 132 are provided hereinafter in regard to the typical operation of the system 100.

The system 100, as depicted in FIG. 1, is a non-limiting exemplary embodiment of the present invention. As such, other system embodiments (not shown) in accordance with the present invention can also be defined and used, which are more or less complex (i.e., inclusive of greater or fewer networked devices) than the system 100 of FIG. 1. Therefore, it is to be understood that the system 100 of FIG. 1 is intended to depict one of an unlimited number of possible embodiments of the present invention.

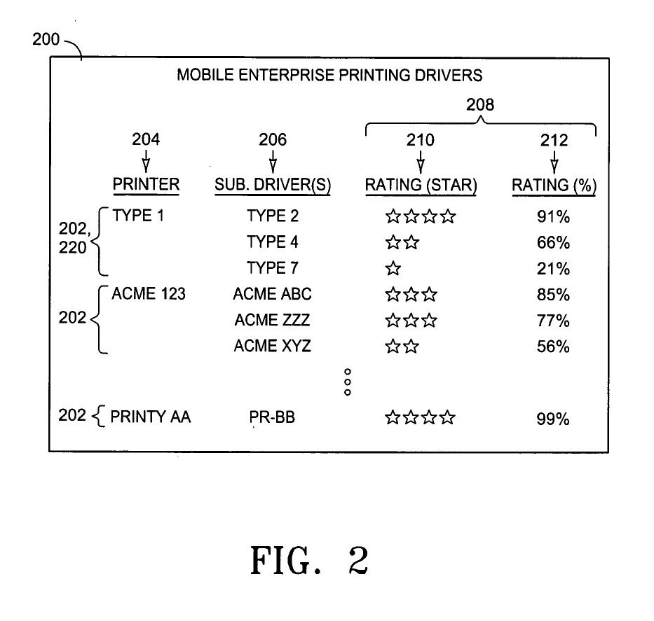

FIG. 2 is a block diagram depicting a database listing 200, in accordance with the system 100 of FIG. 1. In particular, the database listing 200 substantially corresponds to (depicts) the data-type contents and structure of the computer-accessible database 126 of the MEP server 122, and/or the network-accessible database 136 of the MEP host 132 of FIG. 1.

The database listing 200 includes a number of data records 202 generally arranged as rows and columns of associated data, such that a matrix is generally defined. Each data record 202 includes a printer type identification 204. Each printer type identification 204 typically includes make and model information for a particular kind of imaging apparatus. Other suitable kinds of printer identification information can also be used. Each data record 202 also includes one or more substitute printer driver identifications 206. Each substitute printer driver identification (SPDI) 206 is associated with the printer type identification 204 of that particular data record 202, and provides sufficient information to identify a printer driver (electronic application file) used to derive a print-ready data file for transmission to a specific type of imaging apparatus.

To clarify, a particular data record 202 is designated in FIG. 2 as exemplary data record 220. The exemplary data record 220 includes a printer type identification 204 depicted as a “TYPE 1” imaging apparatus, and further includes three substitute printer driver identifications 206 respectively depicted as “TYPE 2”, “TYPE 4” and “TYPE 7”. Each of the SPDI's 206 of the exemplary data record 220 is thus associated with the “TYPE 1” printer type identification 204. It is important to note that each particular printer type identification 204 (e.g., “TYPE 1”) is generally present within only one data record 202 of the database listing 200, but respective SPDI's 206 can be present within any number of different respective data records 202.

Each of the substitute printer driver identifications 206 within a particular data record 202 is further associated with a pair of compatibility ratings 208. As depicted in FIG. 2, each data record 202 includes both a star-type compatibility rating 210 and a percentage-type compatibility rating 212. Each compatibility rating 210 and 212 is intended to indicate some measure of suitability or overall qualitative performance when using the associated substitute printer driver (as identified by the corresponding SPDI 206) to derive a print-ready data file for the corresponding imaging apparatus (as identified by the printer type identification 204). Thus, each of the compatibility ratings 210 and 212 associates (or correlates) the printer type identification 204 within a given data record 202 with a particular substitute printer driver identification 206 within that same data record 202.

In continuation of the clarifying example introduced above, the exemplary data record 220 includes a star-type compatibly rating 210 of “FOUR STARS” (depicted graphically in FIG. 2) and a percentage-type compatibility rating 212 of “91%” to describe the overall performance of using a “TYPE 2” printer driver to derive a print-ready data file for a “TYPE 1” imaging apparatus. This is compared with a “TWO STARS” compatibly rating 210 and a “66%” compatibility rating 212 to describe using a “TYPE 4” printer driver in cooperation with the “TYPE 1” imaging apparatus of the exemplary data record 220. In this exemplary comparison, the compatibility ratings 210 and 212 indicate that a “TYPE 2” printer driver is generally desirable over a “TYPE 4” printer driver when used in cooperation with a “TYPE 1” imaging apparatus.

Thus, the database listing 200 provides information to a user, such as an information systems manager or other appropriate personnel, enabling them to make informed selections when seeking to use a substitute printer driver in cooperation with a particular imaging apparatus (printer). It is to be understood that in another embodiment (not shown) of the database listing 200, only one of the star-type compatibility ratings 210 or the percentage-type compatibility ratings 212 is present. Furthermore, it is to be understood that other types of compatibility ratings not specifically depicted herein can also be used in accordance with the present invention.

A number of typical, non-limiting exemplary operations are now described hereafter in order to convey a fuller appreciation and understanding of the systems and methods of the present invention.

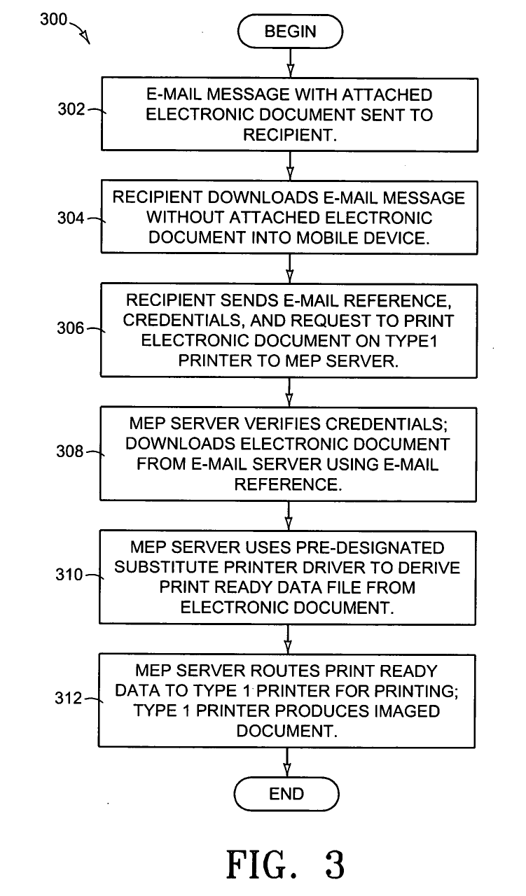

FIG. 3 is a flowchart 300 depicting a method, in accordance with the present invention. For purposes of understanding, the method of the flowchart 300 is described within the context of the system 100 of FIG. 1 and the database listing of FIG. 2. However, the method of the flowchart 300 is generally usable in accordance with any number of other embodiments of the present invention.

In step 302 (FIG. 3), a user produces an electronic message (i.e., e-mail) on the user computer 102 (FIG. 1) using a suitable application 106. The electronic message, along with an attached electronic document (e.g., spreadsheet, word processing document, graphic illustration, etc.), is then transmitted to a particular recipient and is stored as a waiting electronic message 138 on the e-mail server 104. In another embodiment (not shown) of the system 100, the MEP server 122 is further configured to function as an e-mail server, and the discrete e-mail server 104 is not included.

In step 304 (FIG. 3), the recipient (user) of the e-mail transmitted in step 302 above downloads the electronic message 138 (FIG. 1), without the electronic document attachment, from the e-mail server 104 into the mobile device 118 by way of the wireless bridge 116 and wireless signals 120. The user of the mobile device notes that an electronic document was attached to (i.e., associated with) the original e-mail transmission and that such electronic document awaits download or other operations.

In step 306 (FIG. 3), the recipient user of the mobile device 118 (FIG. 1) sends a request (i.e., issues a command) to the MEP server 122 calling for the electronic document attachment to be printed. The issued print command includes a reference to the particular electronic message, one or more credentials or security identifications, and an identification of the particular imaging apparatus to be used. In this example, it is assumed the first type printer 110 is the identified printer, either by direct user selection, as a default setting in the mobile device 118, or in accordance with the electronic document attachment content.

In step 308 (FIG. 3), the MEP server 122 (FIG. 1) receives the print command issued by the mobile device 118 by way of the network 108, and thereafter verifies the associated credentials information. The MEP server 122 then downloads the electronic document attachment from the e-mail server 104 using the electronic message reference and the associated credentials provided with the print command issued in step 306 (FIG. 3) above. The print command reception, credentials verification, and electronic document download operations just described are typically performed in accordance with a corresponding mobile enterprise printing application 128 that is executed by the MEP server 122.

In step 310 (FIG. 3), the MEP server 122 (FIG. 1) uses a pre-designated (i.e., pre-selected) substitute printer driver 124 to derive a print-ready data file from the electronic document. It is assumed for purposes of example that the particular substitute printer driver 124 has been pre-designated for use in association with the first type printer 110 by an appropriate administrative user such as an information systems manager or other authorized person.

In step 312 (FIG. 3), the MEP server 122 (FIG. 1) then sends the print-ready data file derived in step 310 (FIG. 3) above to the first type printer 110 (FIG. 1) by way of the network 108. The first type printer 110 receives the print-ready data file from the MEP server 122 and images one or more sheets of media (e.g., paper, etc.) in accordance therewith, thus producing an imaged document corresponding to the original electronic document attachment. The method of flowchart 300 is now considered complete for one operational example.

The method of the flowchart 300 provides one operational example of the system 100 of FIG. 1 under typical “up and running” conditions. That is, the method of the flowchart 300 is generally performed after (or between) any administrative adjustments to the system 100, such as the designation of the particular substitute printer driver 124 that is operationally associated (used in conjunction) with the first type printer 110. Other methods of the present invention, which are respectively associated with generally administrative operations of the system 100 of FIG. 1, are described in detail hereinafter.

Furthermore, it is to be understood that the electronic message, as described in step 302 (of FIG. 3) above, can include more than one attached electronic document when transmitted to its intended recipient. In such a case, the recipient user would typically provide appropriate selection information within the print command issued in step 306 above, corresponding to those electronic document attachments that are to be printed. Of course, each of the selected electronic documents is then downloaded in step 308, respective print-ready data files for each of the selected electronic document are derived in step 310, and the respective print-ready data files are routed to the first type printer 110 (or whichever imaging apparatus was identified in the issued print command of step 306) in step 312.

In yet another method of the present invention (not shown), a recipient user can receive an electronic message with no attachments at all, in which case the recipient user can elect to substantially perform all of the steps 304-312, as described above, in regard to printing just the text (content) of the electronic message itself. Other method variations can also be used within the context of the present invention.

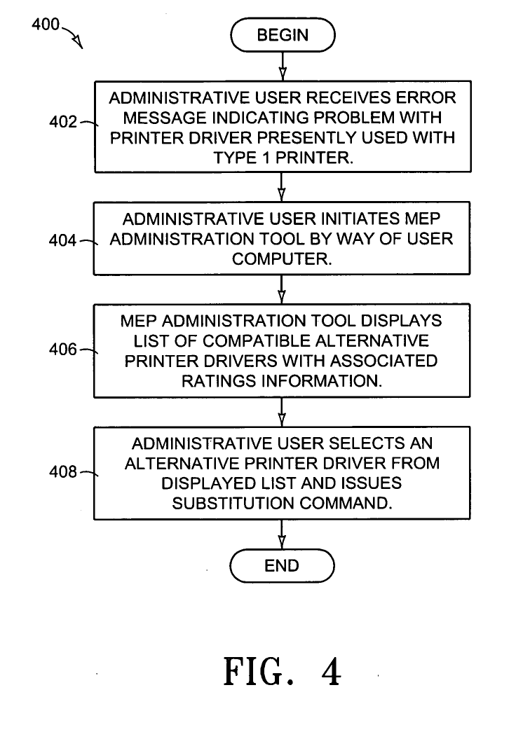

FIG. 4 is a flowchart 400 depicting another method, in accordance with the present invention. While the method of the flowchart 400 is described within the context of the system 100 of FIG. 1 and the database listing 200 of FIG. 2, it is to be understood that the method of the flowchart 400 can be applied to any number of other suitable embodiments of the present invention.

In step 402 (FIG. 4), an administrative user or other typically authorized person receives an error message from the MEP server 122 (FIG. 1) by way of the user computer 102 indicative of a problem with the particular printer driver 124 that is presently designated for use with the first type printer 110.

In step 404 (FIG. 4), the administrative user initiates (runs) an application program 128 (FIG. 1) generally referred to as an MEP administration tool at the MEP server 122. In another embodiment, the MEP administration tool can be provided as an application 106 within the user computer 102. In any case, the MEP administration tool (i.e., an application program) 128 is initiated by way of the user computer 102.

In step 406 (FIG. 4), the MEP administrative tool 128 (FIG. 1) accesses the computer-accessible database 126 of the MEP server 122 and reads the one or more data records 202 (FIG. 2) contained therein. In turn, the MEP administrative tool 128 (FIG. 1) causes a corresponding database listing 200 (FIG. 2) to be displayed by way of a monitor of the user computer 102 (FIG. 1).

In step 408 (FIG. 4), the administrative user selects from the substitute printer driver identifications 206 (FIG. 2), using the star-type compatibility ratings 210 and/or percentage-type compatibility ratings 212 as a guide, in order to choose a substitute printer driver 124 (FIG. 1) to be associated with the first type printer 110. For purposes of example, it is assumed that the administrative user chooses the “TYPE 2” (FIG. 2) substitute printer driver and issues a selection command to that affect to the MEP server 122 (FIG. 1) by way of the user computer 102. The MEP server 122 responds to the selection command by implementing an operational association between a “TYPE 2” printer driver 124 and the first type printer 110. Thus, any subsequent requests to print using the first type printer 110 will result in the use of the “TYPE 2” printer driver 124 by the MEP server 122 to derive the corresponding print-ready data file. A single operation of the method of the flowchart 400 is now considered complete.

The method of the flowchart 400 is therefore generally directed to the administrative task of establishing (implementing) a substitute printer driver for use with a particular imaging apparatus of the system 100 of FIG. 1. As described above, such an implementation is typically performed in response to an error message or other indication that the presently associated printer driver (e.g., a “TYPE 1” printer driver, not shown) is dysfunctional or otherwise unsuitable. Other criteria can also be used to prompt such a substitution, such as, for example, an administrative user's experience that a particular substitute printer driver 124 results in a more satisfactory imaged document when a particular electronic document (source) and imaging apparatus (printer) combination have been selected.

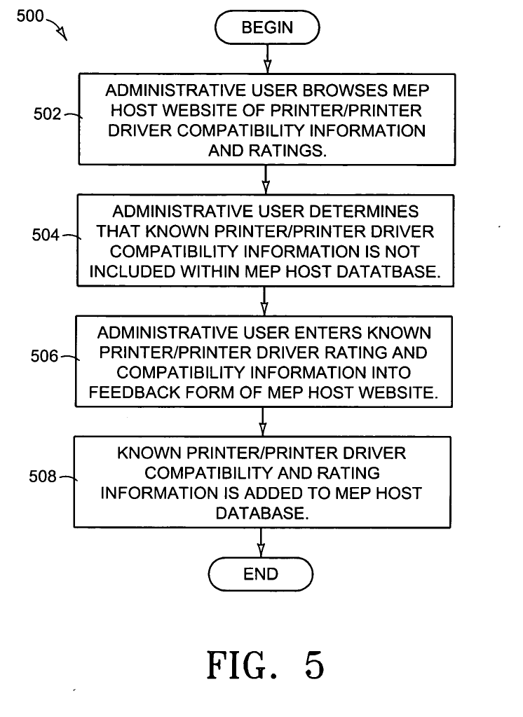

FIG. 5 is a flowchart 500 depicting still another method, in accordance with the present invention. For purposes of understanding, the method of flowchart 500 is described within the context of the system 100 of FIG. 1 and the database listing 200 of FIG. 2. However, it is to be understood that the method of the flowchart 500 can be generally applied to any number of other suitable embodiments of the present invention.

In step 502 (FIG. 5), an administrative user browses one or more web pages 134 (FIG. 1) of the MEP host 132 by way of the user computer 102, the network 108 and the Internet 130. The web pages 134 provide viewable access to data records of the network-accessible database 136 of the MEP host 132, resulting in a database listing substantially analogous (structurally similar) to the database listing 200 of FIG. 2. Thus, the administrative user at the user computer 102 is able to browse an Internet-accessible (i.e., publicly accessible) listing of various printer type identifications (see the printer driver identifications 204 of FIG. 2), substitute printer driver identifications (see the SPDI's 206 of FIG. 2), and their corresponding compatibility ratings (see the compatibly ratings 210 and 212 of FIG. 2).

In step 504 (FIG. 5), the administrative user determines that a particular printer-type and substitute-printer-driver combination that is known to be suitable to the administrative user is not included within the data records of the network-accessible database 136 (FIG. 1) of the MEP host 132.

In step 506 (FIG. 5), the administrative user enters the known (new) printer type identification, substitute printer driver identification, and at least one compatibility rating (i.e., star-type, percentage-type, etc.) into a data input (feedback) form provided by the web pages 134 (FIG. 1) of the MEP host 132. The administrative user then issues a command committing the entered information to the MEP host 132.

In step 508 (FIG. 5), the MEP host 132 (FIG. 1) then adds the new user-entered information from step 506 above to the network-accessible database 136. In this way, the new information is made available to other users who access the network-accessible database 136 of the MEP host 132. A single operation of the method of the flowchart 500 is now complete.

The method of the flowchart 500 generally describes one way in which a collective database, or clearinghouse, of printer identifications, substitute printer drivers and compatibility ratings data can be provided in a publicly accessible and updateable forum. Other suitable methods that are similar to the method of the flowchart 500 can also be used, which respectively include other method steps and/or orders of execution.

For example, in another method (not shown), an administrative user can discover that a certain printer type and substitute printer driver combination is already present within the network-accessible database 136, but the administrative user does not agree with the corresponding compatibility rating as provided. In such a case, the administrative user can provide input via a data input form of the web pages 134 that changes, or affects a weighted averaging, of the particular compatibility rating. In another, similar method (not shown), the administrative user can provide brief textual comments that are viewable by way of the web pages 134, so as to give generally concise information relating to specific advantages and/or problems with the cited printer type and substitute printer driver combination. Other methods can also be used.

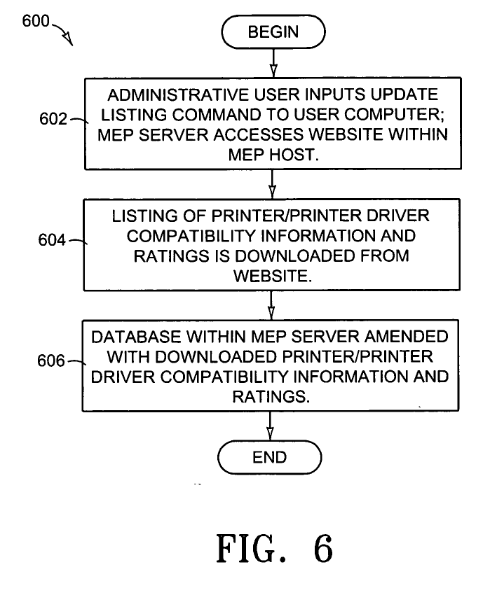

FIG. 6 is a flowchart 600 depicting yet another method, in accordance with the present invention. The method of the flowchart 600 is described within the context of the system 100 of FIG. 1 and the database listing 200 of FIG. 2, for clarity of understanding. However, it is to be understood that the method of the flowchart 600 is generally applicable to any number of other suitable embodiments of the present invention.

In step 602 (FIG. 6), an administrative user inputs (issues) an update listing (i.e., update) command to the MEP server 122 (FIG. 1) by way of the user computer 102 and the network 108. In response to the issued update command, the MEP server 122, in accordance with a corresponding mobile enterprise printing (i.e., update) application 128, establishes a communications link (accesses) with the network-accessible database 136 of the MEP host 132 by way of the Internet 130.

In step 604 (FIG. 6), the MEP server 122 (FIG. 1) downloads the current contents (data records) from the network-accessible database 136 into the MEP server 122. For purposes of this example, it is assumed that the data records (e.g., see the data records 202 of FIG. 2) of the network-accessible database 136 are downloaded in their entirety in anticipation of a full computer-accessible database 126 replacement. In another method, the MEP server 122 selectively downloads only certain ones of the data records (or portions thereof), in accordance with a comparison between the data record content of the computer-accessible database 126 and the network-accessible database 136. In such a later method, only those data records of the network-accessible database 136 which are new and/or different relative to the data records of the computer-accessible database 126 are downloaded.

In step 606 (FIG. 6), the MEP server 122 (FIG. 1) amends the computer-accessible database 126 using the data records downloaded in step 604 above. For purposes of this example, it is assumed that the entirety of the computer-accessible database 126 is replaced with the downloaded data record content. In the case of the later method introduced above in step 604, the data records of the computer-accessible database 126 are added to and/or certain of them are altered so as to bring the computer-accessible database 126 into to complete or substantially complete correspondence with the network-accessible database 136. A single operation of the method according to the flowchart 600 is now complete.

In using the method of the flowchart 600, the computer-accessible database 126 is substantially updated with the latest available printer driver identification, substitute printer driver identification and compatibility ratings information. While the method of FIG. 6 describes an update procedure that is substantially manually initiated, one of skill in the art can appreciate that the same or similar such methods can be generally automated and performed, for example, at fixed intervals of time, after a pre-selected number of print operations are performed, etc.

It will also be appreciated that the flowcharts 300, 400, 500 and 600 of respective FIGS. 3, 4, 5 and 6, described above, are exemplary only, and that different, additional, and/or fewer steps can be used, and the steps performed in different sequence than presented, all in accordance with embodiments of the present invention.

While the above methods and apparatus have been described in language more or less specific as to structural and methodical features, it is to be understood, however, that they are not limited to the specific features shown and described, since the means herein disclosed comprise preferred forms of putting the invention into effect. The methods and apparatus are, therefore, claimed in any of their forms or modifications within the proper scope of the appended claims appropriately interpreted in accordance with the doctrine of equivalents.

1. A system, comprising:
a server configured to be coupled in data communication with a network, the server including a computer-accessible database of one or more data records, each of the one or more data records including:
a printer type identification;
one or more substitute printer driver identifications associated with the printer type identification; and
one or more compatibility ratings associated with the printer type identification and a particular one of the one or more substitute printer driver identifications.

2. The system of claim 1, and further comprising a printer configured to be coupled in data communication with the network, the printer defining a printer type substantially equivalent to the printer type identification of at least one of the data records of the computer-accessible database.

3. The system of claim 2, and wherein the server includes at least one substitute printer driver associated with the printer.

4. The system of claim 1, and wherein the server is defined by a mobile enterprise printing server.

5. The system of claim 1, and further comprising a user computer configured to be coupled in data communication with the network, the user computer configured to:
access the computer-accessible database of the server by way of the network in response to a user input;
display a listing corresponding to the contents of at least one of the one or more data records of the computer-accessible database;
receive a user selection input corresponding to one of the one or more substitute printer driver identifications; and
issue a substitute printer driver selection command to the server by way of the network in response to the user selection input.

6. The system of claim 5, and wherein the server is further configured to establish an operational association between a particular substitute printer driver and a particular printer coupled to the network in accordance with the substitute printer driver selection command issued by the user computer.

7. The system of claim 1, and wherein the server is further configured to:
receive an update command;
access a predetermined Internet website by way of the network in response to the update command, the Internet website hosting a network-accessible database;
download one or more data records available from the network-accessible database of the Internet website; and
amend the computer-accessible database of the server in accordance with the one or more downloaded data records.

8. The system of claim 7, and wherein the server is further configured to add at least one of the one or more downloaded data records to the computer-accessible database of the server.

9. The system of claim 7, and wherein the server is further configured to download the one or more data records in accordance with a comparison between the network-accessible database of the Internet website and the computer-accessible database of the server.

10. The system of claim 1, and further comprising:
an e-mail server configured to be coupled in data communication with the network;
a wireless bridge configured to couple one or more devices in wireless data communication with the network; and
a mobile device configured to be coupled in wireless data communication with the network by way of the wireless bridge, the mobile device further configured to:
selectively download an electronic message from the e-mail server by way of the wireless bridge in response to a user input, the electronic message referencing one or more associated electronic documents not downloaded to the mobile device;
receive an input corresponding to a user selection of one or more of the electronic documents; and
issue a print command to the server by way of the wireless bridge in response to the input, the print command including a reference to the electronic message, a reference to the one or more user selected electronic documents, at least one credential, and a printer type reference.

11. The system of claim 10, and further comprising a printer coupled in data communication with the network, the printer defining a printer type corresponding to the printer type reference of the print command, and wherein the server is further configured to:
receive the print command issued by the mobile device by way of the wireless bridge;
verify the at least one credential of the print command;
download the one or more user selected electronic documents from the e-mail server in accordance with the associated reference;
convert the one or more user selected electronic documents into respective print ready data files using a predetermined substitute printer driver of the server; and
send the one or more print ready data files to the printer.

12. The system of claim 1, and wherein at least one of the one or more compatibility ratings is defined by one of a star rating, or a percentage rating.

13. A method of data communication, comprising:
downloading an electronic message referencing one or more associated electronic documents;
issuing a print command including a reference to the electronic message, a selection of at least one of the one or more associated electronic documents, at least one credential, and a printer type reference;
converting the at least one selected electronic document into a print ready data file using a substitute printer driver corresponding to the printer type reference; and
imaging the at least one printer ready data file on sheet media using a printer corresponding to the printer type reference.

14. The method of claim 13, and further comprising verifying the at least one credential prior to the converting the at least one selected electronic document and the imaging the at least one print ready data file.

15. The method of claim 13, and further comprising downloading the at least one selected electronic document from an e-mail server in accordance with the reference to the electronic message.

16. The method of claim 13, and further comprising establishing an operational association between the printer and the substitute printer driver prior to the downloading the electronic message.

17. A method of managing a system, comprising:
receiving an error message indicative of an operational problem with a printer driver of the system;
accessing a computer-accessible database including one or more data records;
displaying a listing corresponding to the contents of the one or more data records, each data record including a printer type identification, one or more substitute printer driver identifications associated with the printer type identification, and one or more compatibility ratings associated with the printer type identification and a particular one of the substitute printer driver identifications;
issuing a selection command corresponding to a particular one of the displayed substitute printer driver identifications; and
establishing an operational association between a substitute printer driver and a printer of the system in accordance with the selection command.

18. The method of claim 17, further comprising:
converting an electronic document into a print ready data file using the substitute printer driver; and
imaging the print ready date file on sheet media using the printer.

19. The method of claim 17, and wherein the accessing the computer-accessible database is further defined by accessing the computer-accessible database by way of an Internet website.

20. The method of claim 17, and wherein the accessing the computer-accessible database is further defined by accessing the computer-accessible database of a mobile enterprise printing server.

21. A method of maintaining a database, comprising:
browsing an Internet website hosting a network-accessible database, the network-accessible database including one or more data records;
determining that a particular known printer type identification, an associated substitute printer driver identification, and a compatibility rating associated with the printer type identification and the substitute printer driver identification, are not present within the one or more data records of the network-accessible database;
entering the particular known printer type identification, the associated substitute printer driver identification, and the associated compatibility rating into a feedback form of the Internet website; and
amending the network-accessible database in accordance with the particular known printer type identification, the associated substitute printer driver identification, and the associated compatibility rating, entered into the feedback form.

22. The method of claim 21, and wherein the entering the associated compatibility rating into the feedback form of the Internet website is further defined by entering one of a star rating, or a percentage rating.

23. A method of managing a database, comprising:
issuing an update command to a server, the server including a computer-accessible database;
accessing a predetermined network-accessible database in response to the update command;
downloading at least one data record from the network-accessible database, the at least one data record including a printer type identification, one or more substitute printer drivers associated with the printer type identification, and one or more compatibility ratings associated with the printer type identification and a particular one of the one or more substitute printer driver identifications; and
amending at least one data record of the computer-accessible database of the server in accordance with the at least one downloaded data record.

24. The method of claim 23, and wherein accessing the predetermined network-accessible database is further defined by accessing the predetermined network-accessible database by way of a predetermined Internet website.

25. An apparatus, comprising:
a computer-readable storage media including an executable program code, the executable program code configured to cause a processor of a server to selectively:
provide an electronic listing corresponding to one or more data records of a database of the server in response to a listing command input, each of the one or more data records including a printer type identification, one or more substitute printer driver identifications associated with the printer type identification, and one or more compatibility ratings associated with the printer type identification and a particular one of the one or more substitute printer driver identifications; and
establish an operational association between a substitute printer driver of the server and a printer coupled in data communication with the server in response to a selection command input.

26. The apparatus of claim 25, and wherein the executable program code is further configured to cause the processor of the server to selectively amend at least one data record of the database of the server using one or more data records downloaded from a predetermined network-accessible database in response to an update command input.

27. A data system, comprising:
means for imaging sheet media;
means for displaying contents of one or more data records, each data record including a printer type identification, one or more substitute printer driver identifications associated with the printer type identification, and one or more compatibility ratings associated with the printer type identification and a particular one of the substitute printer driver identifications;
means for establishing an operational association between the means for imaging sheet media and a substitute printer driver means; and
means for amending a database means in accordance with the at least one data record downloaded from a predetermined remote means.

28. An apparatus, comprising:
a computer-accessible storage media including a database of one or more data files, each of the one or more data files including:
a printer type identification;
one or more substitute printer driver identifications associated with the printer type identification; and
one or more compatibility ratings associated with the printer type identification and a particular one of the one or more substitute printer driver identifications.

29. The apparatus of claim 28, and wherein at least one of the one or more compatibility ratings is defined by one of a star rating, or a percentage rating.

30. The apparatus of claim 28, and wherein the database is defined as a mobile enterprise printing database.

31. A method of maintaining a database, comprising:
browsing an Internet website hosting a network-accessible database, the network-accessible database including one or more data records;
determining that a particular known compatibility rating associated with a printer type identification and an associated substitute printer driver identification within the one or more data records of the network-accessible database is inaccurate;
entering information related to the particular known compatibility rating into a feedback form of the Internet website; and
amending the network-accessible database in accordance with the information entered into the feedback form.

32. The method of claim 31, and wherein the amending the network-accessible database is defined by one of replacing a compatibility rating, or weightedly averaging a compatibility rating within the one or more data records of the network-accessible database in accordance with the information entered into the feedback form of the Internet website.

33. The method of claim 31, and wherein the amending the network-accessible database is defined by adding textual comments regarding a compatibility rating to the one or more data records of the network-accessible database in accordance with the information entered into the feedback form of the Internet website.

34. An apparatus, comprising:
a mobile device configured to be coupled in wireless data communication with a network, the mobile device further configured to:
selectively download an electronic message by way of the network in response to a user input, the electronic message referencing one or more associated electronic documents not downloaded to the mobile device;
receive an input corresponding to a user selection of one or more of the associated electronic documents; and
issue a wireless print command to a device of the network in response to the input, the print command including a reference to the electronic message, a reference to the one or more user selected electronic documents, at least one credential, and a printer type reference.
